(19) United States
(12) Patent Application Publication
(10) Pub. No.: US 2021/0141858 A1
(43) Pub. Date: May 13, 2021

(54) DATA PREDICTION DEVICE, METHOD, AND PROGRAM

(71) Applicant: NIPPON TELEGRAPH AND TELEPHONE CORPORATION, Tokyo (JP)

(72) Inventors: Maya OKAWA, Tokyo (JP); Hiroyuki TODA, Tokyo (JP); Takeshi KURASHIMA, Tokyo (JP)

(73) Assignee: NIPPON TELEGRAPH AND TELEPHONE CORPORATION, Tokyo (JP)

(21) Appl. No.: 17/044,799

(22) PCT Filed: Mar. 20, 2019
(86) PCT No.: PCT/JP2019/011877

§ 371 Date: Oct. 1, 2020

(30) Foreign Application Priority Data
Apr. 3, 2018 (JP) 2018-071497

(51) Int. Cl. G06F 17/16; G06F 17/17; G06F 7/544; G06N 20/00

(52) U.S. Cl. CPC G06F 17/16; G06N 20/00; G06F 7/5443; G06F 17/175

(57) ABSTRACT

It is possible to accurately predict data for a prediction target time.

The operation unit 10 receives high-dimensional array data representing data at each time and external information data that is a tensor or matrix representing external information at each time.

The parameter estimation unit 16 decomposes the high-dimensional array data into a weighted sum of products of a plurality of factor matrices for each rank and decomposes the external information data into a weighted sum of products of a plurality of factor matrices for each rank, under a sparse constraint of weighting parameters for each rank.

The prediction unit 22 predicts the data for a prediction target time based on the weighting parameters for each rank and the plurality of factor matrices for each rank, obtained for the high-dimensional array data.

### TECHNICAL FIELD

The present invention relates to a data prediction apparatus, a method, and a program for predicting data for a prediction target time.

### BACKGROUND ART

High-dimensional array data can be represented by using a tensor.

Here, the high-dimensional array data refers to data with values for a plurality of indexes. Now, it is assumed that n pieces of R-dimensional array data

(i₁,i₂, . . . ,i_{R},yᵢ)

are given.
Such data can be represented by an Rth-order tensor:

[symbol]

[Math. 1]

[symbol]

ᵢ_{₁}_{,i}_{₂}_{, . . . ,i}_{_{R}}=yᵢ (1)

Tensor factorization such as CP decomposition or Tucker decomposition is used to analyze data represented by a tensor (Non Patent Literature 1).

In tensor factorization, a data tensor is decomposed into the form of a product of a plurality of matrices, and therefore a low-dimensional representation of the data is given. These matrices are called “factor matrices” and represent potential patterns corresponding to each dimension of the tensor. If the tensor contains a missing value, the factor matrix is first estimated by using only non-missing data. At the time of prediction, missing values are complemented by multiplying by a matrix learned from the data and restoring the original value. However, in these methods, there is a problem that external information that affects data to be predicted cannot be considered. Thus, a tensor simultaneous factorization method (Non Patent Literature 2) has been proposed. This is a technique for simultaneously decomposing a plurality of tensors corresponding to a plurality of types of data.

As a result, it is possible to make a prediction while taking into account the influence of external factors.

### CITATION LIST

### Non Patent Literature

Non Patent Literature 1: Fvotte, Cdric, Nancy Bertin, and Jean-Louis Durrieu. “Nonnegative matrix factorization with the Itakura-Saito divergence: With application to music analysis”. Neural computation 21. 3 (2009): 793-830.
Non Patent Literature 2: ERMI, Beyza: ACAR, Evrim: CEMGIL, A. Taylan. Link prediction via generalized coupled tensor factorisation. arXiv preprint arXiv: 1208. 6231, 2012.

### SUMMARY OF THE INVENTION

### Technical Problem

However, the method described in Non Patent Literature 2 considers all external information equally, and it is not possible to select information.

Thus, there is a problem that the prediction accuracy is reduced when auxiliary information not related to the data to be predicted is used.

As described above, in the method of the related art, it is not possible to separate the external information that affects the target data and the external information that does not affect the target data.

For this reason, there is a problem that the prediction accuracy is reduced when external information without attributes common to the data to be predicted is included.

The present invention has been made in view of the above circumstances, and an object of the present invention is to provide a data prediction apparatus, a method, and a program capable of accurately predicting data for a prediction target time.

### Means for Solving the Problem

In order to achieve the object described above, a data prediction apparatus according to an embodiment of the present invention is configured to include: an operation unit that receives high-dimensional array data representing data at each time, and external information data, which is a tensor or a matrix representing external information and which is correlated with the high-dimensional array data; a parameter estimation unit that decomposes the high-dimensional array data into a weighted sum of products of a plurality of factor matrices for each rank using weighting parameters for each rank in tensor factorization and decompose the external information data into a weighted sum of products of a plurality of factor matrices for each rank using weighting parameters for each rank and a plurality of factor matrices including a factor matrix common to the high-dimensional array data, under a sparse constraint of the weighting parameters for each rank; and a prediction unit that predicts the data for a prediction target time based on the weighting parameters for each rank and the plurality of factor matrices for each rank, obtained for the high-dimensional array data by the parameter estimation unit.

In addition, a data prediction method according to the present invention is configured to include: receiving, by an operation unit, high-dimensional array data representing data at each time, and external information data which is a tensor or a matrix that represents external information at each time and which is correlated with the high-dimensional array data; decomposing, by a parameter estimation unit, the high-dimensional array data into a weighted sum of products of a plurality of factor matrices for each rank using weighting parameters for each rank in tensor factorization and decomposing the external information data into a weighted sum of products of a plurality of factor matrices for each rank using weighting parameters for each rank and a plurality of factor matrices including a factor matrix common to the high-dimensional array data, under a sparse constraint of the weighting parameters for each rank; and predicting, by a prediction unit, the data for a prediction target time based on the weighting parameters for each rank and the plurality of factor matrices for each rank, obtained for the high-dimensional array data by the parameter estimation unit.

Further, a program of the present invention is a program for causing a computer to function as each unit of the above-described data prediction apparatus.

### Effects of the Invention

As described above, the data prediction apparatus, method, and program of the present invention exhibits an effect of being capable of accurately predict data for a prediction target time by decomposing the high-dimensional array data into a weighted sum of products of a plurality of factor matrices for each rank using weighting parameters for each rank in tensor factorization and decomposing the external information data into a weighted sum of products of a plurality of factor matrices for each rank using weighting parameters for each rank and a plurality of factor matrices including a factor matrix common to the high-dimensional array data, under a sparse constraint of the weighting parameters for each rank.

### BRIEF DESCRIPTION OF DRAWINGS

FIG. 1 is a block diagram of a data prediction apparatus according to an embodiment of the present invention.

FIG. 2 is a diagram illustrating an example of high-dimensional array data stored in a high-dimensional array data storage device.

FIG. 3 is a diagram illustrating an example of external information stored in an external information storage device.

FIG. 4 is a flowchart illustrating a learning processing routine of the data prediction apparatus according to the embodiment of the present invention.

FIG. 5 is a flowchart illustrating a data prediction processing routine of the data prediction apparatus according to the embodiment of the present invention.

### DESCRIPTION OF EMBODIMENTS

Hereinafter, an embodiment of the present invention will be described in detail with reference to drawings.

### SUMMARY

In the embodiment of the present invention, selection of external information is performed by imposing a sparse constraint during simultaneous factorization of tensors. With the tensor simultaneous factorization technique, a tensor (data tensor) representing data and a tensor (or matrices) representing external information are simultaneously decomposed while sharing a factor matrix, and therefore an indirect relationship between data and external information can be captured. At that time, the data tensor is approximated as a product of the plurality of factor matrices. In the embodiment of the present invention, weighting parameters corresponding to each factor matrix is introduced, and the data tensor is approximated as a product of the factor matrix and the weighting parameters of each factor matrix. By imposing a sparse constraint such as a L1 norm to the weighting parameters, unnecessary parameters can be crushed to 0, and a data tensor can be reconstructed at the time of prediction with reference to only some factor matrices.

Configuration of Data Prediction Apparatus According to the Embodiment of Present Invention

Next, the configuration of the data prediction apparatus according to the embodiment of the present invention will be described. As illustrated in FIG. 1, a data prediction apparatus 100 according to the embodiment of the present invention can be configured by a computer including a CPU, a RAM, and a ROM that stores a program for executing each processing routine described later and various data. The data prediction apparatus 100 predicts the population of the arbitrary mesh area for a prediction target time on the basis of high-dimensional array data representing the population at each time of any mesh area in geographic space, and external information data that is a tensor or matrix representing the population at each time of the mesh area near the arbitrary mesh area. As illustrated in FIG. 1, the data prediction apparatus 100 functionally includes an operation unit 10, a parameter estimation unit 16, a parameter storage unit 18, a search unit 20, a prediction unit 22, and an output unit 24.

The operation unit 10 receives various operations from a user on data stored in a high-dimensional array data storage device 12 and an external information storage device 14 described below. The various operations include operations for registering, correcting, and deleting information stored in the high-dimensional array data storage device 12 and the external information storage device 14.

The input means of the operation unit 10 may be anything such as a keyboard, a mouse, a menu screen, or a touch panel. The operation unit 10 can be realized by a device driver of an input unit such as a mouse, or control software for a menu screen.

The search unit 20 receives information on time (week, day, time) that is a prediction target and the location (mesh area). The input means of the search unit 20 may be anything, such as a keyboard, a mouse, a menu screen, or a touch panel. The search unit 20 can be realized by a device driver of an input unit such as a mouse or control software for a menu screen.

The high-dimensional array data storage device 12 stores history information of high-dimensional array data that can be analyzed by the apparatus, and reads the history information of the high-dimensional array data according to a request from the apparatus and transmits the information to the data prediction apparatus 100. The high-dimensional array data is, for example, the transition of population in an arbitrary mesh area in a geographic space, and is composed of a set

{(tᵢ,yᵢ)}ᵢ₌₁^{N}

of time tᵢ and the number of people yᵢ. Here, N is the number of pieces of data. If the week, the day of the week, and the time slot corresponding to the time tᵢ are set to i₁, i₂, and i₃, respectively, the population transition can be rewritten as a tuple series

{(i₁,i₂,i₃,yᵢ)}ᵢ₌₁^{N}

including four components (see FIG. 2).
Such data is represented by a third-order tensor [symbol] composed of three axes of week i₁, day i₂, and time slot i₃.

Each component of

[symbol]

^{(j)}
corresponds to:

[symbol]

ᵢ_{₁}_{,i}_{₂}_{,i}_{₃}^{(j)}=yᵢ

It is assumed that the tensor in the j-th mesh area is: [symbol]
^{(j)}
The high-dimensional array data storage device 12 is a Web server that stores Web pages, a database server that has a database, or the like.

The external information storage device 14 stores external information that can be analyzed by the apparatus, reads out the external information according to a request from the apparatus, and transmits the information to the data prediction apparatus 100. The external information is data related to an external factor affecting the high-dimensional array data, and is, for example, a set

{ [symbol] ^{(j′)}}_{j′∈}

[symbol]

of population data in a nearby mesh area (see FIG. 3).

### Here,

[symbol] is a set of mesh areas adjacent to the j-th area. Such data is represented by a fourth-order tensor

[symbol]

composed of four axes obtained by adding the index j′ of the mesh area to the week i₁, the day of the week i₂, and the time slot i₃.

The external information storage device 14 is a Web server that stores Web pages, a database server that has a database, or the like.

The parameter estimation unit 16 extracts a low-dimensional expression of the information on the basis of the information stored in the high-dimensional array data storage device 12 and the external information storage device 14, and estimates progression over time. The procedure will be described by using the above example. The procedure considers applying tensor factorization to a tensor representing history information of high-dimensional array data. The tensor factorization is an approximating method using a product of factor matrices. The goal of the present embodiment is to find a set of factor matrices that reproduce the original tensor well. The data tensor

[symbol]

of the high-dimensional array data is decomposed as follows.

$$\begin{matrix}[ Math . 2 ] & \\ y ( j ) \sim {\sum }_{k = 1}^{K} {b}_{k} {v}_{k}^{( 1 )} {• v}_{k}^{( 2 )} {• v}_{k}^{( 3 )} & ( 2 )\end{matrix}$$

Here,

vₖ⁽¹⁾, vₖ⁽²⁾, vₖ⁽³⁾
are factor matrices,

b={bₖ}ₖ₌₁^{K}

is a weighting parameter for each factor, and K is the number of ranks of tensor factorization, which is manually given on the basis of prior knowledge or determined by cross validation.

◯

represents an outer product of vectors. Similarly, the tensor

[symbol]

representing external information is decomposed as follows.

$$\begin{matrix}[ Math . 3 ] & \\ χ \sim {\sum }_{k = 1}^{K} {a}_{k} {v}_{k}^{( 1 )} {• v}_{k}^{( 2 )} {• v}_{k}^{( 3 )} {• v}_{k}^{( 4 )} & ( 3 )\end{matrix}$$

Here,

a={aₖ}ₖ₌₁^{K}

is a weighting parameter for each factor, and
vₖ⁽¹⁾, vₖ⁽²⁾, vₖ⁽³⁾, vₖ⁽⁴⁾
are factor matrices. Here, the factor matrix of the tensor [symbol]
^{(j)}
of high-dimensional array data and the factor matrix of the tensor

[symbol]

of external information are shared. This enables tensor factorization in consideration of external information.

In order to select a factor matrix, a sparse constraint is imposed to weighting parameters:

a, b
Following typical sparse modeling procedures, regularization terms
ψ(a), ψ(b)
for
a, b
are introduced into a likelihood function L.

$$\begin{matrix}[ Math . 4 ] & \\ L = {D}_{β} ( χ \vert \vert \hat{χ} ) + {D}_{β} ( y \vert \vert \hat{y} ) + λΨ ( a ) + λΨ ( b ) & ( 4 ) \\ \hat{y} = {\sum }_{k} {b}_{k} {v}_{k}^{( 1 )} {• v}_{k}^{( 2 )} {• v}_{k}^{( 3 )} & ( 5 ) \\ \hat{χ} = {\sum }_{k} {a}_{k} {v}_{k}^{( 1 )} {• v}_{k}^{( 2 )} {• v}_{k}^{( 3 )} {• v}_{k}^{( 4 )} & ( 6 )\end{matrix}$$

λ is a hyperparameter that controls the effect of a regularization term.

Although the form of a regularization term

ψ(a), ψ(b)
is not limited, the present embodiment introduces a least absolute shrinkage and selection operator (LASSO) that is generally used when selecting features of a regression problem.

[Math. 5]

ψ(a)=|a| (7)

This is a constraint that works in the direction of setting some elements of the vectors

a, b
to 0, and the effect of extracting only those matrices that well explain the target data among the latent matrices shared with the external information can be expected. The likelihood function of this model can be written as:

$$\begin{matrix}[ Math . 6 ] & \\ L = {D}_{β} ( χ \vert \hat{χ} ) + {D}_{β} ( y \vert \hat{y} ) + λ \vert a \vert + λ \vert b \vert & ( 8 ) \\ \hat{y} = {\sum }_{k} {b}_{k} {v}_{k}^{( 1 )} {• v}_{k}^{( 2 )} {• v}_{k}^{( 3 )} & ( 9 ) \\ \hat{χ} = {\sum }_{k} {a}_{k} {v}_{k}^{( 1 )} {• v}_{k}^{( 2 )} {• v}_{k}^{( 3 )} {• v}_{k}^{( 4 )} \\ {D}_{β} ( ϰ \vert y ) & ( 10 )\end{matrix}$$

is an arbitrary distance measure representing the distance between x and y, and is defined by the sum of divergence for each element.

$$\begin{matrix}[ Math . 7 ] & \\ {D}_{β} ( ϰ \vert y ) = {\sum }_{i} {d}_{β} ( {ϰ}_{i} \vert {y}_{i} ) \\ Here , {d}_{β} ( ϰ \vert y ) & ( 11 )\end{matrix}$$

is the divergence between x and y, and is defined by the following equation for
β\∈{0,1}

$$\begin{matrix}[ Math . 8 ] & \\ {d}_{β} ( ϰ \vert y ) = \frac{{ϰ}^{β}}{β ( β - 1 )} + \frac{{y}^{β}}{β} - \frac{{ϰ y}^{β - 1}}{β - 1} & ( 12 )\end{matrix}$$

The β divergence includes Euclidean distance (β=2) and KL divergence (β=1), which are generally used in tensor factorization, as special cases. The following discussion holds for any value of β. The goal of the present embodiment is to estimate a set

[symbol]

={v⁽¹⁾,v⁽²⁾,v⁽³⁾,v⁽⁴⁾}

of factor matrices and weighting parameters
a, b
that minimize the value of the likelihood function L. For optimizing the parameters, for example, an alternating direction multiplier method (ADMM) (Non Patent Literature 3) can be used.

Non Patent Literature 3 Huang, Kejun, Nicholas D. Sidiropoulos, and Athanasios P. Liavas. “A flexible and efficient algorithmic framework for constrained matrix and tensor factorization”. IEEE Transactions on Signal Processing 64. 19 (2016): 5052-5065.

In accordance with the ADMM procedure, the parameter optimization problem of the proposed model is rewritten as the following equation.

[Math. 9]

minimize D_{β}( [symbol] | [symbol] )+D_{β}( [symbol] | [symbol] )—λ|hₐ|+λ|h_{b}| (13)

subject to [symbol] = [symbol] ,W= [symbol] ,a=hₐ,b=h_{b} (14)

The likelihood function can be rewritten as follows.

$$\begin{matrix}[ Math . 10 ] & \\ {L}_{p} ( {\{ {v}_{k}^{( 1 )} , {v}_{k}^{( 2 )} , {v}_{k}^{( 3 )} , {v}_{k}^{( 4 )} \}}_{□}^{K} , a , {b}_{a} , b , {b}_{b} , ℨ , W , {α}_{{b}_{a}} , {α}_{{b}_{b}} , {b}_{z} , {α}_{w} ) = {D}_{\text{?}} ( χ \vert \vert Z ) + {D}_{\text{?}} ( Y \vert \vert W ) + \frac{ρ}{2} \vert \vert Z - \hat{χ} {\vert \vert}_{\text{?}}^{2} + \frac{ρ}{2} \vert \vert W - \hat{y} {\vert \vert}_{y}^{2} + \frac{ρ}{2} < {α}_{z} , Z - \hat{χ} > + \frac{ρ}{2} < {\text{?}}_{w} , W - \hat{y} > + λ \vert {h}_{a} \vert + \frac{ρ}{2} \vert \vert {h}_{\text{?}} - a {\vert \vert}_{y}^{2} + \frac{ρ}{2} < {α}_{{h}_{a}} , {h}_{a} - a > + λ \vert {h}_{a} \vert + \frac{ρ}{2} \vert \vert {b}_{b} - b {\vert \vert}_{y}^{2} + \frac{ρ}{2} < {α}_{{b}_{b}} , {b}_{b} - b > \\ \text{?} \text{indicates text missing or illegible when filed} & ( 15 )\end{matrix}$$

Here,

αₕ_{ₐ}, αₕ_{_{b}}, α_{Z}, α_{W}
are Lagrangian multipliers, and ρ is a hyperparameter that controls the step size. Thereafter, the above equations may be alternately optimized for each of the parameter sets
{vₖ⁽¹⁾,vₖ⁽²⁾,vₖ⁽³⁾,vₖ⁽⁴⁾}ₖ₌₁^{K}, a, b, hₐ, h_{b}, [symbol] , [symbol] , αₕ_{ₐ}, αₕ_{_{b}}, α_{Z}, α_{W}
according to the following equations.

$$\begin{matrix}[ Math . 11 ] & \\ {h}_{a} = {argmin}_{{h}_{a}} λ \vert {h}_{a} \vert + \frac{ρ}{2} \vert \vert {h}_{a} - a {\vert \vert}_{ℱ}^{2} + \frac{ρ}{2} < {α}_{{h}_{a}} , {h}_{a} - a > & ( 17 ) \\ {h}_{b} = {argmin}_{{h}_{b}} λ \vert {h}_{b} \vert + \frac{ρ}{2} \vert \vert {h}_{b} - b {\vert \vert}_{ℱ}^{2} + \frac{ρ}{2} < {α}_{{h}_{b}} , {h}_{b} - b > & ( 18 ) \\ a = {argmin}_{a} \frac{ρ}{2} \vert \vert \overline{W} - {\sum }_{k = 1}^{K} {a}_{k} {v}_{k}^{( 1 )} ∘ {v}_{k}^{( 2 )} ∘ {v}_{k}^{( 3 )} ∘ {v}_{k}^{( 4 )} {\vert \vert}_{ℱ}^{2} + \vert \vert \overline{{h}_{a}} - a {\vert \vert}_{ℱ}^{2} & ( 19 ) \\ b = {argmin}_{b} \frac{ρ}{2} \vert \vert \overline{W} - {\sum }_{k = 1}^{K} {b}_{k} {v}_{k}^{( 1 )} ∘ {v}_{k}^{( 2 )} ∘ {v}_{k}^{( 3 )} {\vert \vert}_{ℱ}^{2} + \vert \vert \overline{{h}_{b}} - b {\vert \vert}_{ℱ}^{2} & ( 20 ) \\ {v}_{k}^{( n )} = {argmin}_{{v}_{2}^{( n )}} \frac{ρ}{2} \vert \vert \overline{Z} - {\sum }_{k = 1}^{K} {a}_{k} {v}_{k}^{( 1 )} ∘ {v}_{k}^{( 2 )} ∘ {v}_{k}^{( 3 )} ∘ {v}_{k}^{( 4 )} {\vert \vert}_{ℱ}^{2} + \overline{W} - {\sum }_{k = 1}^{K} {b}_{k} {v}_{k}^{( 1 )} ∘ {v}_{k}^{( 2 )} ∘ {v}_{k}^{( 3 )} {\vert \vert}_{ℱ}^{2} & ( 21 )\end{matrix}$$

When KL divergence is used as a cost function (β=1), an update equation for

[symbol]

, [symbol]
can be written as the following equation.

$$\begin{matrix}[ Math . 12 ] & \\ ℨ ← \frac{( ρ \hat{χ} - {α}_{Z} - 1 ) + \sqrt{{( ρ \hat{χ} - {α}_{Z} - 1 )}^{2} + 4 ρχ}}{2 ρ} & ( 22 ) \\ W ← \frac{( ρ \hat{χ} - {α}_{w} - 1 ) + \sqrt{{( ρ \hat{y} - {α}_{w} - 1 )}^{2} + 4 ρ y}}{2 ρ} & ( 23 )\end{matrix}$$

The description of the update equations

αₕ_{ₐ}, αₕ_{_{b}}, α_{Z}, α_{W}
of is omitted.

As described above, the parameter estimation unit 16 decomposes the high-dimensional array data into a weighted sum of products of a plurality of factor matrices for each rank using weighting parameters for each rank in tensor factorization and decomposes the external information data into a weighted sum of products of a plurality of factor matrices for each rank using weighting parameters for each rank and a plurality of factor matrices including a factor matrix common to the high-dimensional array data, under a sparse constraint of the weighting parameters for each rank. In other words, the parameter estimation unit 16 repeats updating the weighting parameters for each rank and the plurality of factor matrices for each rank for the high-dimensional array data, and the weighting parameters for each rank and the plurality of factor matrices for each rank for the external information data according to the above equations (17) to (23) in order to optimize a distance between the high-dimensional array data and the weighted sum of products of the plurality of factor matrices for each rank using the weighting parameters for each rank, a distance between the external information data and the weighted sum of products of the plurality of factor matrices for each rank using the weighting parameters for each rank, and the value of the likelihood function L of the above equation (4) expressed by using the regularization terms of the weighting parameters for each rank.

The parameter storage unit 18 stores a set of optimal parameters obtained by the parameter estimation unit 16. The parameter storage unit 18 may be anything as long as the set of estimated parameters is stored and can be restored. For example, the set of estimated parameters is stored in a specific area of a database or a general-purpose storage device (memory or hard disk device) provided in advance.

The prediction unit 22 predicts data for a prediction target time and the location on the basis of the information on a prediction target time and the location received by the operation unit 10, and the weighting parameters for each rank for the high-dimensional array data and a plurality of factor matrices for each rank stored in the parameter storage unit 18.

For example, in the case of the above example, the population at the time corresponding to a prediction target time (day i₂ of the i₁-th week, time slot i3) can be estimated by the following equation.

$$\begin{matrix}[ Math . 13 ] & \\ {\hat{𝓎}}_{{i}_{1} , {i}_{2} , {i}_{3}} = {( {\sum }_{k} {b}_{k} {v}_{k}^{( 1 )} {•v}_{k}^{( 2 )} {•v}_{k}^{( 3 )} )}_{{i}_{1} , {i}_{2} , {i}_{3}} & ( 24 )\end{matrix}$$

The output unit 24 outputs the result predicted by the prediction unit 22. Here, the output is a concept including displaying on a display, printing on a printer, sound output, transmission to an external apparatus, and the like. The output unit 24 may or may not include an output device such as a display or a speaker. The output unit 24 can be realized by driver software for an output device, or driver software for an output device and an output device.

Operation of Data Prediction Apparatus According to Embodiment of Present Invention

Next, the operation of the data prediction apparatus 100 according to the embodiment of the present invention will be described.

Learning Processing Routine

First, when history information of the high-dimensional array data is input from the operation unit 10, the data prediction apparatus 100 stores the history information of the high-dimensional array data in the high-dimensional array data storage device 12, and when external information is input by the operation unit 10, stores the external information in the external information storage device 14. Then, the data prediction apparatus 100 executes a learning processing routine illustrated in FIG. 4.

First, in step S100, each of the parameter sets

{vₖ⁽¹⁾,vₖ⁽²⁾,vₖ⁽³⁾,vₖ⁽⁴⁾}ₖ₌₁^{K}, a, b, hₐ, h_{b}, [symbol] , [symbol] , αₕ_{ₐ}, αₕ_{_{b}}, α_{Z}, α_{W}
is initialized.

In step S102, on the basis of the parameter sets

{vₖ⁽¹⁾,vₖ⁽²⁾,vₖ⁽³⁾,vₖ⁽⁴⁾}ₖ₌₁^{K}, a, b, hₐ, h_{b}, [symbol] , [symbol] , αₕ_{ₐ}, αₕ_{_{b}}, α_{Z}, α_{W}
the weighting parameters
a, b, hₐ, h_{b}
are updated according to the above equations (17) to (20).

In step S104, on the basis of the parameter sets

{vₖ⁽¹⁾,vₖ⁽²⁾,vₖ⁽³⁾,vₖ⁽⁴⁾}ₖ₌₁^{K}, a, b, hₐ, h_{b}, [symbol] , [symbol] , αₕ_{ₐ}, αₕ_{_{b}}, α_{Z}, α_{W}
the factor matrices
{vₖ⁽¹⁾,vₖ⁽²⁾,vₖ⁽³⁾,vₖ⁽⁴⁾}ₖ₌₁^{K}
are updated according to the above equation (21).

In step S106, on the basis of the parameter sets

{vₖ⁽¹⁾,vₖ⁽²⁾,vₖ⁽³⁾,vₖ⁽⁴⁾}ₖ₌₁^{K}, a, b, hₐ, h_{b}, [symbol] , [symbol] , αₕ_{ₐ}, αₕ_{_{b}}, α_{Z}, α_{W}
the tensors [symbol]
, [symbol]
are updated according to the above equations (22) and (23).

Also, αₕ_{ₐ}, αₕ_{_{b}}, α_{Z}, α_{W}

are updated.

In step S108, it is determined whether a predetermined convergence determination condition is satisfied, and if the convergence determination condition is not satisfied, the process returns to step S102, and on the other hand, if the convergence determination condition is satisfied, the process proceeds to step S110.

As the convergence determination condition, a condition where the estimated change amount of each parameter is equal to or less than a threshold or that a predetermined number of repetitions is reached may be used.

In step S110, the parameter sets

{vₖ⁽¹⁾,vₖ⁽²⁾,vₖ⁽³⁾,vₖ⁽⁴⁾}ₖ₌₁^{K}, a, b, hₐ, h_{b}, [symbol] , [symbol] , αₕ_{ₐ}, αₕ_{_{b}}, α_{Z}, α_{W}
finally updated in steps S102 to S106 are stored in the parameter storage unit 18, and the learning processing routine ends.

Data Prediction Processing Routine

Next, the data prediction processing routine illustrated in FIG. 5 will be described.

When the learning processing routine is executed, the parameter sets

{vₖ⁽¹⁾,vₖ⁽²⁾,vₖ⁽³⁾,vₖ⁽⁴⁾}ₖ₌₁^{K}, a, b, hₐ, h_{b}, [symbol] , [symbol] , αₕ_{ₐ}, αₕ_{_{b}}, α_{Z}, α_{W}
are stored in the parameter storage unit 18, and information on a prediction target time and the location is input, the data prediction apparatus 100 executes a data prediction processing routine illustrated in FIG. 5.

In step S20, the operation unit 10 receives information on the prediction target time and the location.

In step S122, the parameter sets

vₖ⁽¹⁾, vₖ⁽²⁾, vₖ⁽³⁾, b
for the high-dimensional array data stored in the parameter storage unit 18 are read.

In step S124, on the basis of the parameter sets read in step S122, the population for the week, day of the week, time slot, and location corresponding to the prediction target time is predicted according to the above equation (24).

In step S126, the output unit 24 outputs the population for the week, day of the week, time slot, and location corresponding to the prediction target time, predicted in step S124 as a result and ends the data prediction processing routine.

As described above, according to the data prediction apparatus according to the embodiment of the present invention, it is possible to select only information that explains the data well from a plurality of types of external information and accurately predict the data for a prediction target time by decomposing the high-dimensional array data into a weighted sum of products of a plurality of factor matrices for each rank using weighting parameters for each rank in tensor factorization and decomposing the external information data into a weighted sum of products of a plurality of factor matrices for each rank using weighting parameters for each rank and a plurality of factor matrices including a factor matrix common to the high-dimensional array data, under a sparse constraint of the weighting parameters for each rank.

The present invention is not limited to the embodiment described above, and various modifications and applications are possible without departing from the gist of the present invention.

For example, in the above embodiment, the case where a tensor representing external information is used has been described as an example, but the invention is not limited to the case, and a matrix representing external information may be used.

Further, the above-described data prediction apparatus 100 includes a computer system inside, but the “computer system” includes an environment for providing homepages (or environment for displaying homepages) if a WWW system is used.

In addition, in the specification of the present application, the embodiment in which the program is installed in advance has been described, but the program can be provided by being stored in a computer-readable recording medium, or can be provided via a network.

### REFERENCE SIGNS LIST

10 Operation unit
12 High-dimensional array data storage device
14 External information storage device
16 Parameter estimation unit
18 Parameter storage unit
20 Search unit
22 Prediction unit
24 Output unit
100 Data prediction apparatus

1.-7. (canceled)

8. A computer-implemented method for predicting aspects of data, the method comprising:
receiving multi-dimensional array data representing data at a time;
receiving external information data, wherein the external information data represents external information having correlated to the multi-dimensional array data at the time;
decomposing the multi-dimensional array data into a first weighted sum of products of a plurality of factor matrices for each rank using weighting parameters for each rank in tensor factorization;
decomposing, based on a sparse constraint of the weighting parameters for each rank, the external information data into a second sum of products of the plurality of factor matrices for each rank using the weighting parameters for each rank and a plurality of factor matrices, wherein a factor matrix comprises a factor matrix common to the multi-dimensional array data;
predicting, based on the weighting parameters for each rank and the plurality of factor matrices for each rank according to the received multi-dimensional array data, a set of data for a prediction target time; and
providing the predicted set of data.

9. The computer-implemented method of claim 8, the method further comprising:
estimating a first distance between the multi-dimensional array data and the weighted sum of products of the plurality of factor matrices for each rank using the weighting parameters for each rank;
estimating a second distance between the external information data and the weighted sum of products of the plurality of factor matrices for each rank using the weighting parameters for each rank;
estimating the weighting parameters for each rank and the plurality of factor matrices for each rank for the multi-dimensional array data; and
estimating, based on optimizing a likelihood function represented by using regularization terms of the weighting parameters of each rank, the weighting parameters for each rank and the plurality of factor matrices for each rank for the external information data.

10. The computer-implemented method of claim 8,
wherein the multi-dimensional array data represent a first population at each time of an arbitrary mesh area in a geographic space, and
wherein the external information data represent a second population at each time of a mesh area in proximity of the arbitrary mesh area.

11. The computer-implemented method of claim 8, wherein the multi-dimensional array data include high-dimensional array data.

12. The computer-implemented method of claim 8, wherein the time relates to a target time for estimating data, and wherein the time includes one or more a week, a day of the week, and the time.

13. The computer-implemented method of claim 8, the method further comprising:
receiving history information of the multi-dimensional array data for machine learning;
receiving external information for machine learning;
updating, based at least on sets of parameter data associated with the received multi-dimensional array data, the weighting parameters;
updating, based at least on the sets of parameter data, the plurality of factor matrices;
updating, based at least on the sets of parameter data, tensor data; and
storing, based on a convergence condition for machine learning, the updated weighing parameters, the updated plurality of factor matrices, and the updated tensor data, wherein the convergence condition relates to at least one of a predetermined threshold of data updates and a predetermined number of data updates.

14. The computer-implemented method of claim 10, wherein the mesh area represents a location in a geographic space, and wherein the predicted set of data relates to a population in the arbitrary mesh area at the prediction target time.

15. A system for predicting aspects of data, the system comprises:
a processor; and
a memory storing computer-executable instructions that when executed by the processor cause the system to:
receive multi-dimensional array data representing data at a time;
receive external information data, wherein the external information data represents external information having correlated to the multi-dimensional array data at the time;
decompose the multi-dimensional array data into a first weighted sum of products of a plurality of factor matrices for each rank using weighting parameters for each rank in tensor factorization;
decompose, based on a sparse constraint of the weighting parameters for each rank, the external information data into a second sum of products of the plurality of factor matrices for each rank using the weighting parameters for each rank and a plurality of factor matrices, wherein a factor matrix comprises a factor matrix common to the multi-dimensional array data;
predict, based on the weighting parameters for each rank and the plurality of factor matrices for each rank according to the received multi-dimensional array data, a set of data for a prediction target time; and
provide the predicted set of data.

16. The system of claim 15, the computer-executable instructions when executed further causing the system to:
estimate a first distance between the multi-dimensional array data and the weighted sum of products of the plurality of factor matrices for each rank using the weighting parameters for each rank;
estimate a second distance between the external information data and the weighted sum of products of the plurality of factor matrices for each rank using the weighting parameters for each rank;
estimate the weighting parameters for each rank and the plurality of factor matrices for each rank for the multi-dimensional array data; and
estimate, based on optimizing a likelihood function represented by using regularization terms of the weighting parameters of each rank, the weighting parameters for each rank and the plurality of factor matrices for each rank for the external information data.

17. The system of claim 15,
wherein the multi-dimensional array data represent a first population at each time of an arbitrary mesh area in a geographic space, and
wherein the external information data represent a second population at each time of a mesh area in proximity of the arbitrary mesh area.

18. The system of claim 15, wherein the multi-dimensional array data include high-dimensional array data.

19. The system of claim 15, wherein the time relates to a target time for estimating data, and wherein the time includes one or more a week, a day of the week, and the time.

20. The system of claim 15, the computer-executable instructions when executed further causing the system to:
receive history information of the multi-dimensional array data for machine learning;
receive external information for machine learning;
update, based at least on sets of parameter data associated with the received multi-dimensional array data, the weighting parameters;
update, based at least on the sets of parameter data, the plurality of factor matrices;
update, based at least on the sets of parameter data, tensor data; and
store, based on a convergence condition for machine learning, the updated weighing parameters, the updated plurality of factor matrices, and the updated tensor data, wherein the convergence condition relates to at least one of a predetermined threshold of data updates and a predetermined number of data updates.

21. The system of claim 17, wherein the mesh area represents a location in a geographic space, and wherein the predicted set of data relates to a population in the arbitrary mesh area at the prediction target time.

22. A computer-readable non-transitory recording medium storing computer-executable instructions that when executed by a processor cause a computer system to:
receive multi-dimensional array data representing data at a time;
receive external information data, wherein the external information data represents external information having correlated to the multi-dimensional array data at the time;
decompose the multi-dimensional array data into a first weighted sum of products of a plurality of factor matrices for each rank using weighting parameters for each rank in tensor factorization;
decompose, based on a sparse constraint of the weighting parameters for each rank, the external information data into a second sum of products of the plurality of factor matrices for each rank using the weighting parameters for each rank and a plurality of factor matrices, wherein a factor matrix comprises a factor matrix common to the multi-dimensional array data;
predict, based on the weighting parameters for each rank and the plurality of factor matrices for each rank according to the received multi-dimensional array data, a set of data for a prediction target time; and
provide the predicted set of data.

23. The computer-readable non-transitory recording medium of claim 22, the computer-executable instructions when executed further causing the system to:
estimate a first distance between the multi-dimensional array data and the weighted sum of products of the plurality of factor matrices for each rank using the weighting parameters for each rank;
estimate a second distance between the external information data and the weighted sum of products of the plurality of factor matrices for each rank using the weighting parameters for each rank;
estimate the weighting parameters for each rank and the plurality of factor matrices for each rank for the multi-dimensional array data; and
estimate, based on optimizing a likelihood function represented by using regularization terms of the weighting parameters of each rank, the weighting parameters for each rank and the plurality of factor matrices for each rank for the external information data.

24. The computer-readable non-transitory recording medium of claim 22,
wherein the multi-dimensional array data include high-dimensional array data;
wherein the multi-dimensional array data represent a first population at each time of an arbitrary mesh area in a geographic space, and
wherein the external information data represent a second population at each time of a mesh area in proximity of the arbitrary mesh area.

25. The computer-readable non-transitory recording medium of claim 22, wherein the time relates to a target time for estimating data, and wherein the time includes one or more a week, a day of the week, and the time.

26. The computer-readable non-transitory recording medium of claim 22, the computer-executable instructions when executed further causing the system to:
receive history information of the multi-dimensional array data for machine learning;
receive external information for machine learning;
update, based at least on sets of parameter data associated with the received multi-dimensional array data, the weighting parameters;
update, based at least on the sets of parameter data, the plurality of factor matrices;
update, based at least on the sets of parameter data, tensor data; and
store, based on a convergence condition for machine learning, the updated weighing parameters, the updated plurality of factor matrices, and the updated tensor data, wherein the convergence condition relates to at least one of a predetermined threshold of data updates and a predetermined number of data updates.

27. The computer-readable non-transitory recording medium of claim 24, wherein the mesh area represents a location in a geographic space, and wherein the predicted set of data relates to a population in the arbitrary mesh area at the prediction target time.
